(19) United States
(12) Patent Application Publication
(10) Pub. No.: US 2022/0369807 A1
(43) Pub. Date: Nov. 24, 2022

(54) Bed Reader Blanket

(71) Applicant: Holly Lena Carson, Rancho Cucamonga, CA (US)

(72) Inventor: Holly Lena Carson, Rancho Cucamonga, CA (US)

(21) Appl. No.: 17/755,283

(22) PCT Filed: Feb. 10, 2021
(86) PCT No.: PCT/US21/70136

§ 371 Date: Apr. 26, 2022

(51) Int. Cl. A47B 23/06; A47G 9/02

(52) U.S. Cl. CPC A47B 23/06; A47G 9/0223

(57) ABSTRACT

A Bed Reader Blanket comprises a conventional blanket with an integrated pliable solid filled equilateral tetrahedral support shape incorporated into the corners that also has a hemispherical channel/edge connectively attached to the interface between the tetrahedral resting shape and the blanket for resting reading materials against while reading. The Bed Reader Blanket has particular utility for readers who read in bed at night or otherwise in darkness while positioned generally supine, prostrate, or recumbent on one's left or right side because it automatically provides an appropriate connectively attached resting surface for a book/screen at each corner of a blanket because the tetrahedral shape is self-leveling when integrated into the corner of a blanket. Finding the tablet rest is as simple as moving your hand to the corner of the blanket and having both top corners with the tetrahedral rest facilitates easy repositioning for reading while turning over.

### TECHNICAL FIELD OF THE INVENTION

The present invention relates generally to blankets used for comforting, sleeping, and warmth and to pillows or cushions such as may be used on beds or lounges, and to support books, magazines, electronic reading devices, and the like adjustably in various convenient reading positions. The present invention relates more specifically to multi-functional blankets wherein the pillow or cushion is used for supporting books, magazines, electronic reading devices, and the like adjustably in various convenient reading positions for reading while positioned generally supine, prostrate, or recumbent on one's left or right side.

### BACKGROUND

Today's pillows and cushions useful for resting a digital reading surface or book against are composed of various shaped devices with and without an attached book rest at the edges or bottom and seemingly none are available already attached to a blanket for use while positioned generally supine, prostrate, or recumbent on one's left or right side.

There are various means for positioning reading material for readers positioned generally supine, prostrate, or recumbent on one's left or right side, but they are cumbersome and typically require some means of prior attachment to the bed (or other lounging/resting surface) or some means of physically stabilizing the device to the location where the reader will rest and read. For example, publication US-A1-2002/116762 (Mastandrea) and publication US-A1-2002/116762 (Chen) disclose a blanket having a weighted perimeter or thickened perimeter.

There is no existing solution for providing a convenient book rest for a bed reader, that does not also require multiple, less-than-convenient devices be brought along, mechanically pre-attached to the surrounding lounging environment, and/or physically intrusive on the lounging surface (bed). In particular, there is no existing solution for providing a convenient book rest for a bed reader who lounges on the left or right side and then wishes to reposition to face the opposite direction and be able to move reading material to the opposite side without having to have duplicate less-than-convenient devices be brought along, mechanically pre-attached to the surrounding lounging environment, and/or physically intrusive on the lounging surface (bed).

### BRIEF SUMMARY OF THE INVENTION

According to a first aspect of the invention, there is a bed reader blanket for supporting a reading book, magazine or tablet, comprising: a modified blanket wherein at least a first corner has a first reading rest comprising a support shape in a form of a tetrahedron thinnest along a first edge which crosses the first corner and increasingly thickens the first corner towards a perimeter extremity of the first corner.

Optionally, the bed reader blanket has a form of a conventional blanket, except for the reading rest(s). Optionally the support shape (reading rest(s)) integrated into the corner(s) has a form of an equilateral tetrahedron. So, the bed reader blanket may be made economically by modifying a conventional blanket, and in particular by modifying a corner of the conventional blanket. Optionally the bed reader blanket comprises a first ledge. The first ledge may have a hemispherical top on a flat base or a channel or L shaped cross-section for resting (leaning, propping up, holding) reading materials (books, magazines, tablet personal computers, smartphones) and digital presentation screens (iPad, tablet, kindle, etc., & gaming screens) against while reading. The perimeter extremity may be co-located with the tip of the first corner of the bed reader blanket.

The bed reader blanket has particular utility for those readers who read in bed at night or otherwise in darkness as it is specifically designed for use to read (game, video conference, etc.) while positioned generally supine, prostrate, or recumbent on one's left or right side while automatically providing an appropriate connectively attached resting surface for a book/screen at each corner of a blanket (reading rest).

The bed reader blanket has in use an upper surface and a lower surface. The thickness of the bed reader blanket is the thickness between these surfaces. The thickness of the bed reader blanket at the first corner extremity is the distance between the point of the corner on the upper surface and the point on the corner on the lower surface. So, the perimeter extremity of the bed reader blanket may comprise corner points of the bed reader blanket on the upper and lower surface. However, some blankets have rounded or chamfered corners; in which case, the first corner extremity is the outer most point away from the centre of the bed reader blanket surface on these rounded or chamfered corners.

In order to prop up a book or tablet, the first reading rest has a form of a wedge at the first corner which wedges apart the upper and lower surfaces of the blanket at the first corner. When the bed reader blanket is horizontal, the first corner upper surface is raised upwards apart from the lower surface. The first reading rest may be thinnest across the first corner between edges of the bed reader blanket which meet at the perimeter extremity. The first edge where the first reading rest is thinnest may lie diagonally across the first corner. The book or tablet bottom rests conveniently on the first edge and is raised up for reading by the raised upper surface.

The first corner may be considered as a region of the which includes the first reading rest which increasingly thickens the first corner towards the perimeter extremity of the first corner. The first corner which may be considered as a region may also include a form of a wedge at the first corner which wedges apart the upper and lower surfaces of the blanket at the first corner.

Optionally, the first reading rest has a distal second edge at the perimeter extremity of the first corner and there the first reading rest is thickest relative the first edge. So in use the highest point of the bed reader blanket is at the corner point of the upper surface. The lowest point is on the surface on which the bed reader blanket rests.

The support shape may be attached onto or filled into a corner of a conventional blanket so as to modify it into becoming the modified blanket. The support shape is wedge shaped to separate the upper and lower surfaces of the bed reader blanket at the first corner. The support shape may be thinnest along the first edge which crosses the first corner of the modified blanket. Thus the thin edge of the wedge may be placed across the corner. The support shape increasingly thickens from the first edge where the reading rest is thinnest to a distal and substantially perpendicular second edge which optionally coincides with the perimeter extremity of the first corner. The distal second edge may be aligned and/or collinear with the perimeter extremity. Substantially perpendicular here means within ten degrees of a right angle.

Optionally, the support shape is solid and pliable. So the bed reader blanket is ready instantly for use when set down on a horizontal surface. The pliability provides comfort. Alternatively, the support shape may be inflatable to take the form in which it increasingly thickens. It may be deflatable to a thickness of a conventional blanket.

Optionally, the tetrahedron is an equilateral tetrahedron. A tetrahedron is a special wedge shape which fits conveniently onto or into a first corner of a rectangular blanket. The tetrahedron provides a convenient triangular face to rest a book or tablet against. The tetrahedron works equally well to separate both free ‘upper’ and ‘lower’ corner faces. So the bed reader blanket is usable whether the blanket is set down right side up or upside down. The equilateral tetrahedron support shape will also present a usable book or tablet reading rest when set down on either side.

Alternatively, at least one of the six edges of the tetrahedron may have a length which is longer or shorter than one or more of the other five edges. Optionally two of the edges which diverge away as a v-shape from the first edge of the tetrahedron may be shorter than the first edge. The v-shape with short edges could provide more distance between adjacent corners of the bed reader blanket than a v-shape with edges the same length as the first edge.

The bed reader blanket has particular utility for readers who read in bed at night or otherwise in darkness while positioned generally supine, prostrate, or recumbent on one's left or right side because it automatically provides an appropriate connectively attached resting surface for a book/screen at each corner of a blanket because the tetrahedral shape is self-leveling when integrated into the corner of a blanket, finding the tablet rest is as simple as moving your hand to the corner of the blanket, and having both top corners with the tetrahedral rest facilitates easy repositioning for reading while turning over.

The bed reader blanket, implemented with the equilateral tetrahedral support shape, has particular utility for readers who choose to utilize the corner reader rest not in its usual position (somewhat to the side while they remain under the blanket), but rather with the support shape positioned upon the body (e.g. flopped upon the abdomen) because the equilateral tetrahedral shape will self-right to provide an immediately useful reading material rest for leaning reading materials regardless of which surface it lands upon due to its equilateral tetrahedral shape. The equilateral tetrahedral shape offers four equal triangular surfaces; therefore, when any one side of the equilateral tetrahedron is laying on a surface, there are three of them that are vertical and leaning back at a convenient angle for resting reading materials.

Optionally the first edge of the tetrahedron crosses the first corner between edges of the bed reader blanket which meet at the perimeter extremity. Thus a thin edge of the tetrahedron is set across a face of the corner. The tetrahedron thickens toward the corner distal from first edge. Thus the shape of the tetrahedron is inherently ideal for thickening the first corner of the bed reader blanket toward the corner points on the upper and lower surfaces.

Between the corner point on the upper and lower surfaces of the first corner, there may be a second edge of the tetrahedron which coincides with the perimeter extremity where the bed reader blanket is thickest. The second edge may be substantially perpendicular to the first edge of the tetrahedron.

Optionally the thickness of the bed reader blanket at the corner perimeter is at least five centimeters and at most forty centimeters. This thickness provides a convenient slant up from the first edge of the reading rest to prop up a book or tablet for reading.

The modified blanket may be rectilinear with four corners including the first corner. So the modified blanket is easily made from a conventional blanket.

Optionally, the bed reader blanket has a second corner which has a second reading rest which increasingly thickens the second corner towards the perimeter extremity of the second corner. So a book or tablet may be conveniently read propped against either the first or second corner.

Optionally, the reading rest comprises a first ledge proximate and/or adjacent and/or adjoining and/or parallel to a thinnest section of the reading rest. So the bottom of the book or tablet may rest against the first ledge. The first ledge prevents the book or tablet from sliding down the raised face of the reading rest. The first ledge may be a ridge which runs across the first corner between edges of the bed reader blanket which meet at the perimeter extremity. So the first ledge is easily placed on or into the modified blanket using the thin edge of support shape as a guide. Optionally the first ledge is formed of a channel. The channel is characterized by a U-shaped cross section. The first ledge may have a L shaped cross section. Both the U and L shaped cross sections have a flat base from which a wall extends. The base is thin like the thin edge of the support shape. The wall catches the bottom of a book or tablet. The book or tablet is prevented from sliding down the first corner by the wall. The first ledge may be resilient and/or pliable for comfort.

Optionally, the first ledge has a hemispherical cross section curving over the blanket to a central ridge above the conventional blanket surface. A channel with a hemispherical cross section may be made easily by cutting a pipe in half and creating a hemispherical curving surface for a person to comfortably rest his or her book against if he or she falls asleep.

Optionally, there is a second ledge of the same form as the first ledge and extending from the opposite surface of the blanket as the first ledge. The flat base of the first ledge may be face to face with the flat base of the second ledge. This allows the bed reader blanket to be usable whether the blanket is set down right side up or upside down.

The support shape may comprise the first ledge and optionally also the second ledge. So the bed reader blanket may be made by attaching just one piece, the support shape, to a corner of a conventional blanket.

Optionally, the first and/or second ledge has a thickness and/or radius of at least half a centimeter and at most three centimeters. This thickness catches the mere bottom of the book or tablet but does not obscure the reading surface.

The support shape may fill the first corner between a first free corner portion and a second free corner portion of the modified blanket. The first and second corner portions may easily be made by separating first and second plies of the conventional blanket or by splitting or slicing fabric at the first corner of the conventional blanket.

Optionally, any one of the six edges of the tetrahedron is matched to a respective edge of the first or second free corner portions. Thus, the modified blanket is easily made since any of the edges of tetrahedron may be so used. The tetrahedron is a type of support shape which may have all six edges the same length. Optionally, two of the six edges of the tetrahedron are matched to two respective edges of the first free corner portion and two others of the six edges of the tetrahedron are matched to two respective edges of the second free corner portion. The first ply may have two edges which converge to a corner tip of the first ply. These two edges of the first ply may make up the two of the six edges of the tetrahedron that are matched to two respective edges of the first free corner portion. The second ply may also have two edges which converge to a corner tip of the second ply. These two edges of the first ply may make up the two of the six edges of the tetrahedron that are matched to two respective edges of the second free corner portion. Each free corner portion made by each ply may be triangular to cover a triangular face of the tetrahedron.

An elastic band or elastic retaining strap (or any similar stretchy fabric) may be connectively attached to the exterior reading rest for the purpose of holding a reading screen or book in place if desired. The elastic band may be attached at plurality of locations upon the exterior surface of the reading rest to enable holding in any number of preferred ways with the elastic band as desired for the specific utility (screen reader device, book, or magazine) intended.

A book reading light may be installed into the vertical edge of the tetrahedron that separates the original corners of the blanket. The book reading light may be any suitably sized lighting element that would either fit completely inside the corner when not in use, and telescope to use position in either the upward or downward direction or be permanently extended and available. The book reading light may be wired or wireless as is suitable for the intended end use.

A wired or wireless screen charging system may be installed into and incorporated into the reading rest for charging the user's tablet, personal computer, smartphone, or other electronic reader device. The charging system may be in the support shape. It may use inductive charging to protect the person's head and neck from charging wires.

The wired electronic device charger may be connectively attached to the interior of the support shape. The charger may be arranged to provide access to the cords and cables of the wired electronic device charger means for charging of an electronic device and connection to a power source. The charger may be connectively attached to the interior of the 3D support shape and arranged to provide wireless charging of an electronic device when rested upon the reading rest.

A haptics control surface or fabric may be installed onto and/or incorporated into the upper and lower horizontal surfaces of the blanket.

An electrical heated blanket capability may be installed into and/or incorporated between the upper and lower horizontal surfaces of the blanket.

An electrical cooled blanket capability may be installed into and/or incorporated between the upper and lower horizontal surfaces of the blanket.

The heating capability may be included in the first reading rest. It may be in the support shape. Since a person may cover themselves with the rest of the blanket while resting their head near the reading rest to keep warm while reading a book or tablet resting on the reading rest.

The cooling capability may be included in the first reading rest to cool the book or tablet resting on it. The cooling capability may be in the support shape. For example, the first reading rest may comprise an induction charger to charge the tablet which heats up as it charges, the cooling capability thus counteracting the heating.

Other features and options may be installed as well, as needed to accomplish a unique purpose, for an other than conventionally abled person, or some specialized intent. According to a second aspect of the invention, there is a method of making a bed reader blanket for supporting a reading book, magazine, or tablet in bed by incorporating a tetrahedron support shape in a first corner of the blanket, including: creating first and second free corner pieces by parting open the first corner to a length equal to the length of any side of the tetrahedron support shape; separating the free corner pieces apart and inserting the tetrahedron support shape between them orienting the tetrahedron thinnest along an edge which crosses the first corner and increasingly thickens the first corner towards the perimeter extremity of the first corner; and matching any one of the edges of the tetrahedron to an edge of the first or second free corner piece; and closing the free corner pieces onto faces of the tetrahedron.

The tetrahedral shaped screen rest is automatic positioning and easily accessed to the left or right (or any resting position when reaching for a corner of the invented blanket) thereby providing particularly unique utility for those readers who read in bed at night or otherwise in darkness as it is specifically designed for use to read (game, video conference, etc.) while positioned generally supine, prostrate, or recumbent on one's left or right side while automatically providing an appropriate connectively attached resting surface for a book/screen at each corner of a blanket.

The bed reader blanket is specifically designed for use to read (game, video conference, etc.) while positioned supine, prostrate, or recumbent generally while comfortable on the left or right side either partially or completely. The availability of two already properly positioned reader rest locations at the corners of the blanket further provides for a readily available new position for resting the reading material when it becomes necessary or desirous to turn over and face the other direction where currently positioned.

The bed reader blanket is specifically designed for use when reading in bed at night-time or otherwise in darkness with a tablet personal computer-based reading screen device because it has the automatically self-leveling tetrahedral shape in the corner, leaving the corner in a ready to rest the book condition wherever it lands on the resting surface (bed). Further, with reader rests on both upper corners, turning over and moving to new positions while remaining in darkness are simple and convenient with book rests at about arm's length away from any position covered by the blanket.

The equilateral tetrahedral shape is self-leveling when properly integrated into the corner of a blanket. The incorporation of the tetrahedral shape in the corners of the blanket is accomplished by matching any one of the six edges of the tetrahedron to the edge created by opening each corner of the blanket to a length equal to approximately one and one half (1.5) times the length of any side of the tetrahedron to be inserted and incorporated into the corner along each side of the corner and separating the free corner pieces equally upwardly and downwardly so that the tetrahedron can be inserted. Then, after the tetrahedral shape is inserted, two additional fabric pieces, each a triangle whose base is approximately equal in size to the height of the separation between blanket corners and whose height is equal in length to approximately one and one half times the length of any side of the tetrahedron, are arranged so as to cover the two exposed sides of tetrahedron, thereby closing the blanket with the tetrahedral shape inside the blanket.

The convenient, attached, self-leveling tablet stand/rest is physically incorporated into the corners of a blanket (between the upper and lower horizontal surfaces) so finding the tablet rest is as simple as moving your hand down the edge of the blanket to either corner of the blanket wherein the tetrahedral shape is incorporated. Further, because both top corners of the blanket have the tetrahedral rest readily available for use, this facilitates easy repositioning by the reader for reading while comfortable on the opposite site of the body (turning over).

### BRIEF DESCRIPTION OF THE DRAWINGS

The invention may be described by way of example by reference to the accompanying drawings, wherein:

FIG. 1 shows a cross section of a side of a bed reader blanket;

FIG. 2 shows a view of an upper or lower surface of a bed reader blanket; and

FIG. 3 shows a three-dimensional perspective view of a bed reader blanket.

### DETAILED DESCRIPTION

Methods, systems, and apparatuses for reading while positioned generally supine, prostrate, or recumbent on one's left or right side are herein described. The present specification discloses one or more embodiments that incorporate the features of the invention. The disclosed embodiment(s) merely exemplify the invention. The scope of the invention is not limited to the disclosed embodiment(s). The invention is further defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to include such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

The Bed Reader Blanket 1000 comprises a modified conventional blanket 200. At least a first corner 214 has a first reading rest 100 which increasingly thickens the first corner towards the perimeter extremity 50 of the first corner 214. An integrated tetrahedral (spherical, or cubic, octagonal, decagonal, dodecahedral, etc.) three-dimensional (3D) support shape 10 is incorporated into or onto at least one of (and up to all of) the corners of the blanket.

A channel 20 provides an edge for resting (leaning, propping up, holding) reading materials (books, magazines, tablet personal computers, smartphones) and digital presentation screens (iPad, tablet, kindle, etc., & gaming screens) on while reading. Together the 3D support shape 10 and channel 20 form a reading rest 100 at the corner of the Bed Reader Blanket 1000 on the upper horizontal surface 204.

A channel 22 provides an edge for resting (leaning, propping up, holding) reading materials (books, magazines, tablet personal computers, smartphones) and digital presentation screens (iPad, tablet, kindle, etc., & gaming screens) on while reading. Together the 3D support shape 10 and channel 22 form a reading rest 100 at the corner of the Bed Reader Blanket 1000 on the lower horizontal surface 202.

In some embodiments, the 3D support shape 10 fills the corner 214 of the modified blanket 200. In other embodiments the 3D support shape 10 is attached to a surface 204 of the modified blanket 200.

In some embodiments, the channels 20, 22 and the 3D support shape 10 are a single piece. Whereas in other embodiments, the channels 20, 22 and the 3D support shape 10 are three separate pieces. In some embodiments, only channel 20 is used. In some embodiments, only channel 22 is used. In the preferred embodiment, both channels 20, 22 are used for each reading rest 100.

In some embodiments, the 3D support shape 10 fills the corner of the modified blanket 200 and/or is pliable. In some embodiments, the channels 20, 22 have a hemispherical cross section. The cross section has a thickness which provides a ledge on the surface 202, 204 of the modified blanket 200 that in use prevents the bottom of a book, magazine or tablet personal computer from sliding off the reading rest 100.

The modified conventional blanket 200 has a rectilinear configuration with a lower horizontal surface 202, an upper horizontal surface 204, four vertical blanket edges 206, 208, 210, 212, two upper blanket corners 214, 216, and two lower blanket corners 218, 220. All available standard and custom sized blankets may be so configured as to enable the device of the bed reader blanket. However, the conventional blanket 200 is modified at the corner(s) 214 (216, 218, 220) where the reading rest(s) 100 is (are) located.

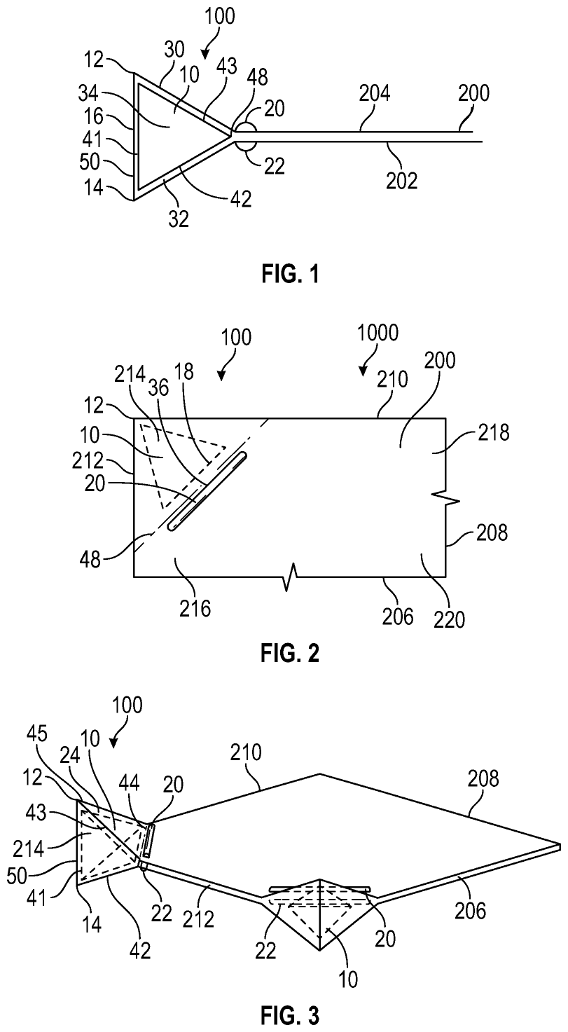

The 3D support shape 10 is thickest along an edge 41 of the Bed Reader Blanket 1000 where the two adjacent edges 210, 212 of the modified blanket 200 meet at the edge 41 between corner two points 12, 14 of the same corner 214. In some embodiments a portion 16 of the modified blanket 200 is attached to the edge 41. The 3D support shape 10 is thinnest along an edge 18 which crosses the corner 214 of the modified blanket 200 from one of the adjacent edges 210, 212 to the other of that corner 214. The thickness of the 3D support shape increases from the first edge 18 to the edge 41 between corner points 12, 14. As the thickness increases, the slope or angle of the horizontal surface of the Bed Reader Blanket 1000 increases. The 3D support shape provides a raised prop for the book, magazine, or tablet. The example of the 3D support shape 10 shown in FIGS. 1, 2 and 3 is a tetrahedron. The distal second edge 41 of the tetrahedron is perpendicular to the first edge 18 of the tetrahedron. The distal second edge 41 of the tetrahedron is aligned with the extremity 50 of the first corner 214. The first edge 18 of the tetrahedron is parallel and adjacent to the meeting edge 48 of free corner faces. The thickness of the bed reader blanket at the perimeter extremity 50 of the first corner is at least five centimeters and at most forty centimeters.

The channel 20 crosses over and is arranged on top of the upper horizontal surface 204. The channel 22 crosses over and is arranged on top of the lower horizontal surface 202. The channels 20, 22 are parallel and adjacent to the thin edge 18 of the 3D support shape 10. The channels 20, 22 cross the corner 214 between adjacent edges 210, 212 of the modified blanket 200. The channels 20, 22 are in use the base of the reading rest 100. The 3D support shape 10 has a triangular face 24 on an upper surface. The triangular face 24 has a corner 12 where the two adjacent edges 210, 212 of the modified blanket 200 meet. The other two corners of the triangular face 24 are where the channels 20, 22 meet or are proximate to the adjacent edges 210, 212. A triangular free corner piece of the upper face of the blanket 200 covers the upper triangular face 24 of the tetrahedron 3D support shape 10. A triangular free corner piece of the lower face of the blanket 200 covers the lower triangular face of the tetrahedron 3D support shape.

The Bed Reader Blanket 1000 comprises a modified blanket 200 that is modified from a conventional blanket. The modified blanket 200 is configured to include at least the 3D support shape and the channel 20 forming a reading rest 100 having an edge 18 as described herein. The modified blanket 200 may optionally be configured to include the 3D support shape and the channel 22 forming a reading rest 100 having an edge 18 as described herein.

Optionally the Bed Reader Blanket 1000 may include an elastic band, a book reading light, haptics control surface on the blanket proximal to the reader rest 100, and/or a wired or wireless charging system for portable personal electronic devices such as smart phones and tablet personal computers.

The reading rest 100 is a pliable filled (solid) equilateral tetrahedral shape incorporated into one of the corners 214 providing a self-righting semi-vertical leaned back angle resting location for resting a tablet personal computer-based reading screen against in a position ergonomically suited to reading while positioned generally supine, prostrate, or recumbent on one's left or right side. In some embodiments, corners 214, 216 at the head end of the Bed Reader Blanket 1000 comprise a reading rest 100. In the preferred embodiment, both corners 214, 216 at the head end of the Bed Reader Blanket 1000 contain a reading rest 100.

The incorporation of the tetrahedral 3D support shape 10 in a corner 214 of the modified blanket 200 is accomplished by matching any one of the six edges (five of the edges 41, 42, 43, 44 and 45 are visible in FIG. 3) of the tetrahedron to corresponding edges created by splitting open the corner 214 of the blanket forming two free corner pieces 30, 32. The triangular upper surface 24 of the top free corner piece 30 is visible in FIG. 3. The free corner pieces 30, 32 are split apart to a length equal to the length of approximately one and one half (1.5) times the length of a side of the tetrahedron to be inserted and incorporated into the corner 214 along each side of the corner 214. Incorporation of the tetrahedral 3D support shape 10 in the corner 214 is further accomplished by separating the free corner pieces 30, 32 equally upwardly and downwardly so that the tetrahedron 3D support shape 10 can be inserted between the free corner pieces 30, 32. Then, after the tetrahedral shape 10 is inserted, two additional fabric pieces (one piece 34 is visible in FIG. 1), each equal in size to the separated corner triangular edges showing the exposed two sides of the tetrahedron are placed on the two remaining exposed sides of the tetrahedron, thereby closing the blanket with the tetrahedral shape inside the blanket. The upper free corner piece 30 and the lower free corner piece 32 meet at a meeting edge 48 across the first corner 214 of the blanket 200. The tetrahedron thin edge 18 and the channel 20 are parallel, adjacent and on opposite sides of the meeting edge 48

A first portion of the channel 20 is installed along the edge 18 of the inserted support 3D support shape 10 (i.e., the equilateral tetrahedral shape as in the preferred embodiment) on the upper horizontal surface 204 of the modified blanket 200. A second portion of the channel 22 is located on the lower horizontal surface 202 opposing the first portion 20. The hemispherical channels 20, 22 provide a connectively attached ledge 36 for resting (leaning, propping up, holding) reading materials (books, magazines, tablet personal computers, smartphones) and digital presentation screens (iPad, tablet, kindle, etc., & gaming screens) against thereby preventing the rested device from slipping down off of the reading rest 100 provided by the corner of the blanket with the tetrahedral 3D support shape 10. The height of the ledge 36 above the upper surface 204 of the blanket is half a centimeter to three and a half centimeters.

Other channels may be installed along, up to, both sides of all six of the edges of the 3D support shape 10 (equilateral tetrahedron) to provide the enhanced utility of additional support edges in ready position for resting the reading material upon when said reading material is leaned against the reading rest 100. An embodiment of the Bed Reader Blanket has a channel installed along both sides of all six edges around the installed tetrahedral 3D support shape 10.

In a first preferred embodiment, there is a bed reader blanket for supporting a reading book, magazine or tablet, comprising: a modified blanket wherein at least a first corner has a first reading rest comprising a support shape in the form of a tetrahedron thinnest along a first edge which crosses the first corner and increasingly thickens the first corner towards the perimeter extremity of the first corner.

In an alternate embodiment, there is a bed reader blanket according to the first preferred embodiment wherein the perimeter extremity comprises a corner point of the bed reader blanket.

In an alternate embodiment, there is a bed reader blanket according to the first preferred embodiment, wherein the first reading rest is thinnest across the first corner between edges of the bed reader blanket which meet at the perimeter extremity.

In an alternate embodiment, there is a bed reader blanket according to the first preferred embodiment wherein the first reading rest is thickest at the perimeter extremity of the first corner.

In an alternate embodiment, there is a bed reader blanket according to the first preferred embodiment wherein the support shape is solid and pliable.

In an alternate embodiment, there is a bed reader blanket according to the first preferred embodiment wherein substantially perpendicular to the first edge of the tetrahedron is a second edge of the tetrahedron which coincides with the perimeter extremity where the bed reader blanket is thickest.

In an alternate embodiment, there is a bed reader blanket according to the first preferred embodiment, wherein the thickness of the bed reader blanket at the perimeter extremity of the first corner is at least five centimeters and at most forty centimeters.

In an alternate embodiment, there is a bed reader blanket according to the first preferred embodiment wherein a second corner has a second reading rest which increasingly thickens the second corner towards the perimeter extremity of the second corner.

In a second preferred embodiment, there is a bed reader blanket for supporting a reading book, magazine or tablet, comprising: a modified blanket wherein at least a first corner has a first reading rest comprising a support shape in the form of a tetrahedron thinnest along a first edge which crosses the first corner and increasingly thickens the first corner towards the perimeter extremity of the first corner wherein the reading rest comprises a ledge proximate and adjacent and parallel to a thinnest section of the reading rest.

In an alternate embodiment, there is a bed reader blanket according to the second preferred embodiment wherein the ledge is a ridge which runs across the first corner between edges of the bed reader blanket which meet at the perimeter extremity.

In an alternate embodiment, there is a bed reader blanket according to the second preferred embodiment wherein the ledge is formed of a channel.

In an alternate embodiment, there is a bed reader blanket according to the second preferred embodiment wherein the ledge has a hemispherical cross section curving over the blanket.

In an alternate embodiment, there is a bed reader blanket according to the second preferred embodiment having a second ledge of the same form as the first ledge and extending from the opposite surface of the blanket as the first ledge.

In an alternate embodiment, there is a bed reader blanket according to the second preferred embodiment wherein the support shape comprises the first ledge.

In an alternate embodiment, there is a bed reader blanket according to the second preferred embodiment wherein the ledge has a thickness and/or radius of at least half a centimeter and at most three centimeters.

In an alternate embodiment, there is a bed reader blanket according to the second preferred embodiment wherein the support shape fills the first corner between a first free corner portion and a second free corner portion of the modified blanket.

In an alternate embodiment, there is a bed reader blanket according to either preferred embodiment wherein any one of the six edges of the tetrahedron is matched to a respective edge of the first or second free corner portions.

In an alternate embodiment, there is a bed reader blanket according to either preferred embodiment wherein two of the six edges of the tetrahedron are matched to two respective edges of the first free corner portion and two other of the six edges of the tetrahedron are matched to two respective edges of the second free corner portion.

In an alternate embodiment, there is a bed reader blanket according to either preferred embodiment wherein the reading rest further comprises an elastic retaining strap connectively attached to the exterior of said modified blanket in at least two places arranged on the exterior of the reading rest to hold a reading book, magazine or tablet in place against the first corner while being read. The book, magazine, or tablet may be held against the tetrahedron triangular face.

In an alternate embodiment, there is a bed reader blanket according to either preferred embodiment wherein the reading rest further comprises a night reading light means connectively attached to the exterior of said modified blanket arranged along at least one edge of the support shape.

In an alternate embodiment, there is a bed reader blanket according to either preferred embodiment wherein the reading rest further comprises a wireless electronic device charger means connectively attached to the interior of the 3D support shape and arranged to provide wireless charging of an electronic device when rested upon the reading rest.

In an alternate embodiment, there is a bed reader blanket according to either preferred embodiment wherein the modified blanket further comprises a haptics control surface means connectively attached to the exterior of the modified blanket and arranged to provide use of a tablet personal computer with the surface of the modified blanket.

In an embodiment, there is a method of making a bed reader blanket for supporting a reading book, magazine or tablet in bed by incorporating a tetrahedron support shape in a first corner of the blanket, including: creating first and second free corner pieces by parting open the first corner to a length equal to the length of any side of the tetrahedron support shape; separating the free corner pieces apart and inserting the tetrahedron support shape between them orienting the tetrahedron thinnest along an edge which crosses the first corner and increasingly thickens the first corner towards the perimeter extremity of the first corner; and matching one of the edges of the tetrahedron to an edge of the first or second free corner piece; and closing the free corner pieces onto faces of the tetrahedron.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A bed reader blanket for supporting a reading book, magazine or tablet, comprising: a modified blanket wherein at least a first corner has a first reading rest comprising a support shape in a form of a one-piece solid tetrahedron thinnest along a first edge which crosses the first corner and increasingly thickens the first corner towards a perimeter extremity of the first corner.

2. The bed reader blanket according to claim 1 wherein the perimeter extremity comprises a corner point of the bed reader blanket.

3. The bed reader blanket according to claim 1 wherein the first reading rest is thinnest across the first corner between edges of the bed reader blanket which meet at the perimeter extremity.

4. The bed reader blanket according to claim 1 wherein the first reading rest is thickest at the perimeter extremity of the first corner.

5. (canceled)

6. The bed reader blanket according to claim 1 wherein substantially perpendicular to the first edge of the tetrahedron is a second edge of the tetrahedron which coincides with the perimeter extremity where the bed reader blanket is thickest.

7. The bed reader blanket according to claim 1 wherein the bed reader blanket has a thickness at the perimeter extremity of the first corner that is at least five centimeters and at most forty centimeters.

8. The bed reader blanket according to claim 1 wherein a second corner has a second reading rest which increasingly thickens the second corner towards the perimeter extremity of the second corner.

9. The bed reader blanket according to claim 1 wherein the first reading rest comprises a first ledge proximate and adjacent and parallel to a thinnest section of the first reading rest.

10. The bed reader blanket according to claim 9 wherein the first ledge is a ridge which runs across the first corner between edges of the bed reader blanket which meet at the perimeter extremity.

11. The bed reader blanket according to claim 9 wherein the first ledge is formed of a channel.

12. (canceled)

13. The bed reader blanket according to claim 9 having a second ledge of the same form as the first ledge and extending from the opposite surface of the blanket as the first ledge.

14. The bed reader blanket according to claim 9 wherein the support shape comprises the first ledge.

15. The bed reader blanket according to claim 9 wherein the ledge has a thickness and/or radius of at least half a centimeter and at most three centimeters.

16. The bed reader blanket according to claim 1 wherein the support shape fills the first corner between a first free corner portion and a second free corner portion of the modified blanket.

17. The bed reader blanket according to claim 16 wherein any one of the six edges of the tetrahedron is matched to a respective edge of the first or second free corner portions.

18. The bed reader blanket according to claim 16 wherein two of the six edges of the tetrahedron are matched to two respective edges of the first free corner portion and two other of the six edges of the tetrahedron are matched to two respective edges of the second free corner portion.

19. (canceled)

20. The bed reader blanket according to claim 1 wherein the first reading rest further comprises a night reading light means connectively attached to the exterior of said modified blanket arranged along at least one edge of the support shape.

21. The bed reader blanket according to claim 1 wherein the first reading rest further comprises a wireless electronic device charger means connectively attached to the interior of the 3D support shape and arranged to provide wireless charging of an electronic device when rested upon the reading rest.

22. The bed reader blanket according to claim 1 wherein the modified blanket further comprises a haptics control surface means connectively attached to the exterior of the modified blanket and arranged to provide use of a tablet personal computer with the surface of the modified blanket.

23. A method of making a bed reader blanket for supporting a reading book, magazine or tablet in bed by incorporating a one-piece solid tetrahedron support shape in a first corner of the blanket, including: creating first and second free corner pieces by parting open the first corner to a length equal to the length of any side of the one-piece solid tetrahedron support shape; separating the free corner pieces apart and inserting the one-piece solid tetrahedron support shape between them orienting the one-piece solid tetrahedron support shape thinnest along an edge which crosses the first corner and increasingly thickens the first corner towards the perimeter extremity of the first corner; and matching one of the edges of the one-piece solid tetrahedron support shape to an edge of the first or second free corner piece; and closing the free corner pieces onto faces of the one-piece solid tetrahedron support shape.
